(19) United States
(12) Patent Application Publication
(10) Pub. No.: US 2005/0032646 A1
(43) Pub. Date: Feb. 10, 2005

(54) Agents for the regulation of gametophytic self-incompatibility and a control method for the breakdown of gametophytic self-incompatibility using the agents

(76) Inventors: Kee-Pyung Nahm, Seoul (KR); Sang-Ku Yoo, Gyeonggi-do (KR); Il-Kyung Chung, Daegu (KR); Il-Sun Chung, Gyeongsanbuk-do (KR)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/500,824

(22) PCT Filed: Oct. 23, 2003
(86) PCT No.: PCT/KR03/02246

(30) Foreign Application Priority Data
Oct. 24, 2002 (KR) 10-2002-0065302

(51) Int. Cl. A01N 25/00

(52) U.S. Cl. 504/116.1

(57) ABSTRACT

This invention relates to the agents for regulating gametophytic self-incompatibility (SI), which inhibit a style-specific S RNase promoting gametophytic self-incompatibility. The invention includes the agricultural composition of the agent of zinc(II) complexes and/or copper(II) complexes for the breakdown of the gametophytic SI of nearly one-half of all the families of angiosperms, including the Rosaceae (apples, pears, cherries, almonds, plums, mango, etc), the Solanaceae (tomatoes, petunia, potatoes tobacco, etc), the Scrophularaceae, and many grasses. The invention also includes a control method for regulating and suppressing gametophytic SI of a gametophytic self-incompatible plant with the agents, and a control method for the production of novel self-pollinated seeds that are produced by the regulation agents.

### TECHNICAL INFORMATION

This invention relates to the agents for regulating and suppressing gametophytic self-incompatibility by the inhibition of the activity of a style-specific S RNase promoting gametophytic self-incompatibility. The invention includes the composition of the agents for suppressing gametophytic self-incompatibility of a plant, a control method for regulating and suppressing gametophytic self-incompatibility of a plant with the agents, and a control method for the production of self-pollinated seeds from self-incompatible plants by this invention. With the agents and the control method of the present invention, a single specie of self-incompatible plants can be self-pollinated without cultivating genetically dissimilar species for cross-pollination, so ,that the pollination rate and the productivity of fruits per unit area can be regulated, and the self-pollinated seed production from self-incompatible plants is possible by this invention.

### BACKGROUND ART

Evolution favors genetic variability, which is promoted by outbreeding, i.e., sexual reproduction between genetically dissimilar parents. But if the flowers have both sex organs; anthers producing pollen (the source of the male gametes) and the pistil producing the egg (the female gamete), there occurs a problem; self-fertilization.

Among many variable solutions, plants with Gametophytic self-incompatibility (GSI) prevent self-fertilization by the operation of genetic mechanisms that allow the pistil to recognize and reject ‘self’ pollen while still being able to accept other types of ‘non-self’ pollen. Among the diversity of SI systems in angiosperms, it is known that some families use the same self-incompatibility system that pollen rejection is controlled by a highly allelic S locus; haploid pollen grains are rejected by diploid pistils when both have the same S allele (Dodds, et al., Cell, (1996) 85, pp 141-144; Kao, et al., Proc. Natl. Acad. Sci. USA, (1996) 93, pp 12059-12065). For example, self-incompatibility plants from the Rosaceae, the Solanaceae and the Scrophularaceae accumulate in their pistils an extracellular ribonuclease (the S-RNase) that is encoded by the S locus,(McClure, et al., Nature, (1989) 342, pp 955-957; Ishimizu, et al., Plant Mol. Biol., (1998) 37, pp 931-941). Analyses in transgenic plants have shown that S-RNases determine the self-incompatibility response of the pistil, and that the ribonuclease activity of these proteins is essential for the rejection of self-pollen (Huang, et al., Plant Cell, (1994) 6, pp 1021-1028).

A variety of traditional techniques have been used to attempt to overcome the self-incompatibility of hybrids produced using SI pollination control systems. These are the use of stored pollen, irradiation, micropropagation, carbon dioxide treatment, other chemical treatments and bud pollination (see, for example, De Nettancourt, (1977) “Incompatibility in angiosperms”, Springer-Verlag; U.S. Pat. No. 3,043,282 (Pearse); U.S. Pat. No. 4,299,687, (Lawrence et al.)). However, these traditional techniques cannot be used on a field scale; extensive field production of the hybrids and fruits of the SI system is impractical due to the production costs. To date, no breeding method or agents have been commercialized for the breakdown of the gametophytic SI system.

It is an object of the present invention to provide a control method for the breakdown of the gametophytic SI of nearly one-half of all the families of angiosperms, including the Rosaceae (apples, pears, cherries, almonds, plums, mango, etc), the Solanaceae (tomatoes, petunia, potatoes, tobacco, etc), the Scrophularaceae, and many grasses.

The inventor previously described the usage of sulfate (SO₄²⁻) originated from MgSO₄, ZnSO₄, CuSO₄, and MnSO₄, to achieve the breakdown of gametophytic SI (WO 0165921 (Chung)). But, through a variety of experiments of the present invention, the inventor could reveal that the active component for the inhibition of a style-specific S RNase promoting gamatophytic self-incompatibility (GSI) is not sulfate (SO₄²⁻) but Zn(II), Cu(II), or Mg(II). That is why the enzyme assay using Li₂SO₄, Na₂SO₄, K₂SO₄, Ce₂SO₄, CaSO₄, etc., didn't show any positive inhibiting effect for a style-specific S RNase extracted from apple (Fuji). And the metal sulfates were slowly absorbed and less potent to the plants. They need to have a high concentration of the metal sulfates at least 0.5 mM to be effective for the breakdown of SI system, but could not go above 1.0 mM because of the side-effect of the sulfate agents, such as discoloration, yellowing, and chlorosis. The main cause of the side effect of the sulfate salts may be the acidic character of the salt (pH 4.5-6.0).

In the present invention, when the ligands of zinc(II) complexes and/or copper(II) complexes are changed to various chelates from inorganic anions to organic ligands, the agents still show potency in the breakdown of gametophytic SI. The present invention clearly shows that neither the sulfate anion nor the metal sulfate salt, but the metal ion itself, Zn(II) and/or Cu(II), is the main component for the inhibition of S RNases and the breakdown of the SI system of the self incompatible plants.

The present invention shows the several advantages in the breakdown of gametophytic SI system; the agents are highly efficient, low toxic, and kinetically fast-working. First, when the Zn(II) complexes and/or Cu(II) complexes with lipophilic ligands are applied on self-incompatible plants, the agents are readily absorbed by the flower organs and more effective even at a lower concentration, which could not be obtained previously with the sulfates. The efficacy of the agents seems to be increased because of a lipophilic character of the L, which appears especially in a field test for the breakdown of gametophytic SI system. Second, the agents show less toxicity and they may have mild acidity of near neutral pH; they are more potent and less toxic to the plants, that expands the applicable concentration of the agent in the range of from sub μM to sub-10th mM. Another advantage of the liophilic ligand is that the agent works faster kinetically and shows the efficacy in the period of from 4-5 days before full bloom to full bloom day, which is good for the filed application.

These several advantages expand the application areas of the present invention; with the regulation agents for the breakdown of gametophytic self-incompatibility according to the present method, a single species of self-incompatible fruit trees can be self-pollinated without cultivating genetically dissimilar species for cross-pollination, so that the fruit self-pollination rate can be achieved and the productivity per unit area can be increased and one can produce the novel self-fertilized seeds from self-incompatible plants by the invention. It may be applied to the gametophytic self-incompatible plants in harsh weather condition and fertilized the plants without bees, insects or birds, and it may reduce the cost in the farming.

The present invention suggests a completely new method of self-fertilization in the gametophytic self-incompatible plants, which is useful to the plant growers and/or the seed producers, especially of the Rosaceae (apples, pears, cherries, almonds, plums, mango, etc) and the Solanaceae (tomatoes, petunias, potatoes, tobacco, etc), the Scrophularaceae, and many grasses. As well, the present invention provides an innovative cultivating method capable of maximizing the yield per the unit area, since high fruition rate can be achieved without assistance of genetically dissimilar cross-species or insects such as bees.

### DISCLOSURE OF INVENTION

It is an object of the present invention to provide a regulation composition of lipophilic zinc(II) complexes and/or copper(II) complexes, which inhibit efficiently a style-specific S RNase activity of SI plants, for suppressing gametophytic SI of self-incompatible plants from the Rosaceae, the Solanacease and the Scrophularaceae. Another object of the present invention is to provide a control method for breaking down the gametophytic self-incompatibility by using the regulation composition. Also the object of the present invention is to provide a control method for producing the ‘self’ pollinated seeds from gametophytic self-incompatible plants by using the regulation composition.

The present invention provides a regulation composition of Cu(II) complexes and/or Zn(II) complexes, Chemical Formula 1, which inhibit efficiently a style-specific S RNase activity of gametophytic SI plants, for suppressing gametophytic SI of self-incompatible plants, such as the Rosaceae (apples, pears, cherries, almonds, plums, mango, etc), the Solanaceae (tomatoes, petunia, potatoes, tobacco, etc), the Scrophularaceae, and many grasses.
MLₙ.yX.wH₂O Chemical Formula 1
wherein:
M is a cation of either copper(II) or zinc(II);
L is a chelate or complex-forming moiety associated with cation M;
X is an anionic element to balance the total charge to neutral;
n is an integer in the range of from 0 to 6;
y is an integer in the range of from 0 to 2; and
w is an integer or fraction in the range of from 0 to 24.
   The parts of water in the Formula 1 represent free or coordinated inner crtstalline water or “bonded” water, which is typically expressed as condensed water of extra-bonded hydrogen bonding hydrophilic groups for structures of the ligands.

And the present invention provides a control method for breaking-down gametophytic self-incompatibility with the agricultural composition of Cu(II) complexes and/or Zn(II) complexes, Chemical Formula 1, as active components. Also the present invention is to provide a control method for producing the novel ‘self’ fertilized seeds from gametophytic SI plants by the present invention.

As shown in the present invention, the gametophytic self incompatibility system is suppressed by treating with the agents of the present invention as style-specific S RNase inhibitors, at the early blooming period (bud forming period to full blooming). The present invention induces the self-pollination and fruition by self-pollen, not by cross-pollination, in the gametophytic self-incompatibility system in a manner of stable pollination, environment-safety, weather-safety and economical benefit.

The present invention suggests a completely new method for self-fertilization in the gametophytic self-incompatible plants, which is useful to the plant growers and/or the seed producers, especially of the Rosaceae (apples, pears, cherries, almonds, plums, mango, etc) and the Solanaceae (tomatoes, petunias, potatoes, tobacco, etc), the Scrophularaceae, and many grasses. As well, the present invention provides an innovative cultivating method capable of maximizing the yield per the unit area, since high fruition rate can be achieved without assistance of genetically dissimilar cross-species or insects such as bees.

### PREFERRED EMBODIMENT OF THE INVENTION

Hereinafter, the present invention is described in details. The present invention provides a regulation composition of Cu(II) complexes and/or Zn(II) complexes with various ligands, which is absorbed fast and inhibits efficiently a style-specific S RNase activity of SI plants, for suppressing gametophytic SI and inducing the self-breeding of self-incompatibility plants. After the organic complex is absorbed at pistil by the plants, the complex may release its metal ion, either Cu(II) or Zn(II), which inhibits a style-specific S RNase activity.

At the above Chemical Formula 1, L is a ligand binding to M and represents either inorganic anion ligand or a conjugate base of organic compounds which are easily deprotonated (O-donor and S-donor; their pKa values are below 20) or N-donating ligands, such as; halides, nitrate, borate, phosphate, perchlorate, ammonia, hydrosulfide, hydroxide, and any combination of them; and carboxylic acids, organo-sulfonic acids, organo-sulfinic acids, organo-sulfenic acids, organo-phosphonic acids, thiocarboxylic acids, alcohols, thiols, phenols, thiophenols, oximes, sulfonamides, sulfonylureas, imides, acetoacetates, thiocarbamate, and any combination of them; and alkyl amines or dialkyl amines or trialkyl amines of C1-C10 alkyl or branched alkyl groups, and polyamine such as ethylenediamine, diethylenetriamine, substituted aromatic amines, alkyl aryl amines, alkyl aryl polyamines, and the azo-aromatic compounds such as imidazole, pyridine, pyrimidine, bipyridine, phenanthrene -and any combination of them.

In the preferred embodiment of the invention of the regulation agents of the Chemical Formula 1 including hydrated forms thereof.
MLₙ.yX.wH₂O
wherein:
M is a cation of either copper(II) or zinc(II);
X is an anionic element to balance the total charge to neutral;
n is an integer in the range of from 1 to 2;
y is an integer in the range of from 0 to 2; and
w is an integer or fraction in the range of from 0 to 24; and
L is a lipophilic ligand from the class of either oxygen-donors or sulfur-donors or nitrogen-donors such as; a conjugate base molecule from the class of carboxylic acid, organo-sulfonic acids, organo-sulfinic acids, organo-sulfenic acids, organo-phosphonic acids, thiocarboxylic acids, alcohols, thiols, phenols, thiophenols, oximes, sulfonamides, sulfonylureas, imides, acetoacetates, and thiocarbamate; and ethylenediamines; diethylenetriamine, polyethyleneimine, imidazole, pyridines, and pyrimidines.

Here the carboxylic acids of conjugate base compounds of L are selected from aliphatic and aromatic acids, and di-, tri-, and tertiary acids, amino acids, and their derivatives; formic acid, chloroacetic acid, dichloroacetic acid, trichloroacetic acid, trifluoroacetic acid, glycolic acid, propionic acid, lactic acid, acrylic acid, butylic acid, metacrylic acid, valeric acid, isovaleric acid, hexanoic acid, octanoic acid, benzoic acid, p-toluic acid, mandelic acid, glycine, alanine, phenyl alanine, cysteine gluconic acid, stearic acid, undecanoic acid, oleic acid, methoxyacetic acid, ethoxyacetic acid, 2-ethyl hexanoic acid, methoxyacetic acid, ethoxyacetic acid, propoxyacetic acid, isopropoxyacetic acid, butoxyacetic acid, tert-butoxyacetic acid, pentoxyacetic acid, phenoxyacetic acid, (4-methoxyphenoxy)acetic acid, (4-methylphenoxy)acetic acid, 2-methoxyethoxyacetic acid, 2-ethoxyethoxyacetic acid, 2-(2-methoxyethoxy)ethoxyacetic acid, 2-(2-ethoxyethoxy)ethoxyacetic acid, 2-methoxypropionic acid, 2-ethoxypropionic acid, 2-propoxypropionic acid, 2-isopropoxypropionic acid, 2-butoxypropionic acid, pentoxypropionic acid, phenoxypropionic acid, 2-(4-methoxyphenoxy)propionic acid, 2-(4-methylphenoxy)propionic acid, 2-(2-methoxyethoxy)propionic acid, 2-(2-ethoxyethoxy)propionic acid, 2-{2-(2-methoxyethoxy)ethoxy}propionic acid, 2-{2-(2-ethoxyethoxy)ethoxy}propionic acid, thiomethoxyacetic acid, 2-thiophenoxypropionic acid, 3-thiophenoxypropionic acid, 3-thiomethoxypropionic acid, 3-thioethoxypropionic acid, 3-thiophenoxypropionic acid, N,N-dimethylaminoacetic acid, N,N-diethylacetic acid, 2-(N,N-dimethylamino)propionic acid, 2-(N,N-diethylamino)propionic acid, 4-methoxybenzoic acid, salicylic acid, cirtic acid, tartaric acid, ethylenediamine tetraacetic acid (EDTA), oxalic acid, malonic acid, maleic acid, succinic acid, adipic acid, or phthalic acid.

Here the organo-sulfonic acids of conjugate base compounds of L are selected from either alkyl sulfonic acids or aryl sulfonic acids; methyl sulfonic acid, ethyl sulfonic acid, propyl sulfonic acid, butyl sulfonic acid, pentyl sulfonic acid, hexyl sulfonic acid, octyl sulfonic acid, dodecyl sulfonic acid, 3-methoxyethyl sulfonic acid, 3-ethoxyethyl sulfonic acid, trifluoromethyl sulfonic acid, benzene sulfonic acid, 4-aminobenzene sulfonic acid, 4-methoxybenzene sulfonic acid, 4-hydroxybenzene sulfonic acid, 4-(2-methoxyethoxy)benzene sulfonic acid, 4-(2-ethoxyethoxy)benzene sulfonic acid, 4-{2-(2-methoxyethoxy) ethoxy}benzene sulfonic acid, 4-{2-(2-ethoxyethoxy)ethoxy}benzene sulfonic acid, 4-isopropylbenzene sulfonic acid, 2,4,6-trimethylbenzene sulfonic acid, or lignosulfonic acid.

Here the organo-sulfinic acids of conjugate base compounds of L are selected from either alkyl sulfinic acids or aryl sulfinic acids; methyl sulfinic acid, ethyl sulfinic acid, propyl sulfinic acid, butyl sulfinic acid, pentyl sulfinic acid, hexyl sulfinic acid, octyl sulfinic acid, dodecyl sulfinic acid, 3-methoxy-ethyl sulfinic acid, 3-ethoxyethyl sulfinic acid, trifluoromethyl sulfinic acid, benzene sulfinic acid, 4-aminobenzene sulfinic acid, 4-methoxybenzene sulfinic acid, 4-hydroxybenzene sulfinic acid, 4-(2-methoxyethoxy)benzene sulfinic acid, 4-(2-ethoxyethoxy)benzene sulfinic acid, 4-{2-(2-methoxyethoxy)ethoxy}benzene sulfinic acid, 4{2-(2-ethoxyethoxy)ethoxy}benzene sulfinic acid, 4-isopropylbenzene sulfinic acid, 2,4,6-trimethylbenzene sulfinic acid, or lignosulfinic acid.

Here the organo-sulfenic acids of conjugate base compounds of L are selected from either alkyl sulfenic acids or aryl sulfenic acids; methyl sulfenic acid, ethyl sulfenic acid, propyl sulfenic acid, butyl sulfenic acid, pentyl sulfenic acid, hexyl sulfenic acid, octyl sulfenic acid, dodecyl sulfenic acid, 3-methoxy-ethyl sulfenic acid, 3-ethoxyethyl sulfenic acid, trifluoromethyl sulfenic acid, benzene sulfenic acid, 4-aminobenzene sulfenic acid, 4-methoxybenzene sulfenic acid, 4-hydroxybenzene sulfenic acid, 4-(2-methoxyethoxy)benzene sulfenic acid, 4-(2-ethoxyethoxy)benzene sulfenic acid, 4-{2-(2-methoxyethoxy)ethoxy}benzene sulfenic acid, 4{2-(2-ethoxyethoxy)ethoxy}benzene sulfenic acid, 4-isopropylbenzene sulfenic acid, 2,4,6-trimethylbenzene sulfenic acid, or lignosulfenic acid.

Here the phenols of conjugate base compounds of L are selected from; phenol, p-methoxyphenol, o-cresol, m-cresol, p-cresol, catechol, resorcinol, and 2-methyl resorcinol.

Here the alcohols of conjugate base compounds of L are selected from; methanol, ethanol, propanol, butanol, isopropanol, isobutanol, pentanol, hexanol, heptanol, octanol, decanol, 2-ethylhexanol, propenol, phenylmethanol, 2-phenylethanol, and 3-hydroxypropionitrile.

Here the oximine compounds of conjugate base compounds of L are oxime derivatives derived from the reaction of hydroxylamine hydrochloric acid with either keones or aldehydes selected from; acetone, acetaldehyde, propanal, butanal, butanone (methyl ethyl ketone), benzaldehyde, 4-methoxy benzaldehyde, actophenone, hexanal, penta-3-one, and 3-methylbuta-2-one.

Here the organo-phosphonic acids of conjugate base compounds of L are selected from; methyl phosphonic acid, propyl phosphonic acid, butyl phosphonic acid, benzyl phosphonic acid, 1-aminoethyl phosphonic acid, 1-amino-2-methylpropyl phosphonic acid, isopropyl phosphonic acid, tert-butyl phosphonic acid, gluco phosphonic acid, or glucose-6-phophate.

An agriculturally active ligand complex of Cu(II) or Zn(II) described in the invention can be prepared according to known processes disclosed, for example, in Ravindranath et al., Tetrahedron (1984) 40, pp 1623-1628, which is incorporated herein by reference; cupper oxide (CuO) or zinc oxide (ZnO) are mixed with ligand compounds described above in the ratio of 1:2 and the mixture is refluxed and dehydrated in toluene using a Dean-Stock system then purified. Depending on the chemical properties of ligands, several different synthetic processes can be applied: for the ligands which have high pKa values, for example alcochols, thiols, oxime compounds, and imide compounds, the synthetic process using diethyl zinc (Et₂Zn) as described in U.S. Pat. No. 5,104,997 can be applied; for the ligands which have low pKa values, for example carboxylic acids, and organic sulfonic acids, their calcium salts or their sodium salts are mixed with either cupper sulfate (CuSO₄) or cupper nitrate (CuNO₃), or zinc sulfate (ZnSO₄), or zinc nitrate (ZnNO₃) in water to yield the product of chemical formula 1. As described the synthetic processes are well known and the agriculturally active ligand complexesof Cu(II) or Zn(II) in the invention can be prepared according to known processes.

The present invention is more specifically illustrated in the following examples. However, it should be understood that these examples are provided only for illustration of the present invention, but not intended to limit the present invention in any manner.

### EXAMPLE 1

### Isolation and Purification of a Style-Specific S RNase, a Control Protein for Gametophytic Self-Incompatibility

Isolation and purification of S RNase from style of Fuji apple were conducted as follows:

One gram of styles of Fuji apple was ground to a fine powder in a mortar with liquid nitrogen. To 5 mL of an extraction buffer (10 mM sodium phosphate (pH 6.0), 10 mM EDTA, 1 mM PMSF and 1% (w/v) polyvinyl pyrrodine), was added the ground pistil powder. The homogenate was centrifuged at 14,000 rpm for 20 min at 4° C. The supernatant was passed through a Centrifree-CL filter (Millipore, USA) to remove unsedimented fine particles. Then the homogenates were applied to a Biogel P-60 column (1.5×89 cm) (Bio-Rad, USA) that had been equilibrated with the same buffer and each 0.5 mL fractions were collected (Harris et al., Plant Physiology, 89: 360-367,1989; Anuradha Singh et al., Plant Physiology, 96: 61-68, 1991; Shihshie et al., Plant Cell, 6: 1021-1028,1994). The fractions that contained the S protein were pooled and further separated by cation-exchange chromatography using a Mono S column (Amersham, UK) and a FPLC system (Bio-Rad, USA). Total of 1,282,000 units of a style-specific S RNase of 23-25 kDa was collected from the styles.

### EXAMPLE 2

### Inhibition of the Tube Growth of Self-Pollen by a Style-Specific S RNase of Fuji Apple

The experiment that verifies the inhibition of the tube growth of self pollen by a style-specific S RNase was conducted as follows. The self-pollen isolated frmn a stamen of Fuji apple was cultured in the mediums which is composed of 20 mM Mes-KOH (pH 6.0), 0.07% Ca(NO₃)₂-4H₂O, 0.02% MgSO₄-7H₂O, 0.01% KNO₃, 0.01% H₃BO₃ and 2% sucrose. Five hundred microliter of pollen suspension was cultured at 28° C. for 24 h and the tube growth of the pollen was observed with a light microscope (×20). To verify the role of S RNase in SI system, the pollen tube growth of self-pollen was cultured in the mediums with each 2, 4 and 6 units of a style-specific S RNase in comparison with the control medium with no a style-specific S RNase. The observation results show that at the higher dosage of S RNase the pollen tube growth was retarded more, which confirms that a style-specifc S RNase induces the gametophytic self-incompatibility.

### EXAMPLE 3

### Inhibition of the Activity of a Style-Specific S RNase by the Agents

Inhibition of S RNase activity by an agent of the present invention was measured as follows: The standard solution of 500 μL of 10 mM sodium phosphate (pH 7.0) with an agent (2.0 mM), and 500 μL of torula yeast rRNA (5 mg/mL) was pre-incubated for 10 min at 37° C. To the substrate solution, the 20 μL of the style-specific S RNase (200 ng) of Fuji apple was added, then the solution was incubated for 30 min at 37° C. A fraction of 200 μL was collected and 40 μL of stop buffer (ice-cold 25% HCIO₄, 0.75% uranyl acetate) was added, then mixed and centrifuged at 12,000 rpm for 5 min. And 50 μL of the supernatant was diluted with 950 μL of dd H₂O, then the solution was centrifuged and measured the optical density at 260 nm (A260) (Singh A. et al., Plant Physilolgy, 96: 61-68,1991). The result is shown in Table 1.

TABLE 1
Inhibition of the activity of a style-specific S RNase by the agents.

| | OD | | OD |
|---|---|---|---|
| agents | (2.0 mM) | agents | (2.0 mM) |
| Zn(II) methoxyacetate | 0.71 | Cu(II) methoxyacetate | 0.72 |
| Zn(II) ethoxyacetate | 0.73 | Cu(II) ethoxyacetate | 0.72 |
| Zn(II) propoxyacetate | 0.75 | Cu(II) propoxyacetate | 0.73 |
| Zn(II) 2-methoxyethoxyacetate | 0.64 | Cu(II) 2-methoxyethoxyacetate | 0.65 |
| Zn(II) 2-(2-methoxyethoxy) | 0.62 | Cu(II) 2-(2-methoxyethoxy) | 0.63 |
| ethoxyacetete | | ethoxyacetete | |
| Zn(II) 2-(2-propoxyethoxy) | 0.69 | Cu(II) 2-(2-propoxyethoxy) | 0.67 |
| ethoxyacetate | | ethoxyacetate | |
| Zn(II) 2-{2-(2-methoxyethoxy) | 0.67 | Cu(II) 2-{2-(2-methoxyethoxy) | 0.66 |
| ethoxy} ethoxyacetate | | ethoxy}ethoxyacetate | |
| Zn(II) 2-methoxypropionate | 0.73 | Cu(II) 2-methoxypropionate | 0.72 |
| Zn(II) 2-propoxypropionate | 0.72 | Cu(II) 2-propoxypropionate | 0.72 |
| Zn(II) 2-(2-methoxyethoxy) | 0.61 | Cu(II) 2-(2-methoxyethoxy) | 0.64 |
| propionate | | propionate | |
| Zn(II) 2-{2-(2-methoxyethoxy) | 0.62 | Cu(II) 2-{2-(2- | 0.61 |
| ethoxy}propionate | | methoxyethoxy)ethoxy} | |
| Zn(II) 4-(2-ethoxyethoxy) | 0.72 | propionate | |
| benzene sulfonate | | Cu(II) 4-(2-ethoxyethoxy) | 0.72 |
| Zn(II) 4-{2-(2-methoxyethoxy) | 0.68 | benzene sulfonate | |
| ethoxy}benzene sulfonate | | Cu(II) 4-{2-(2- | 0.68 |
| Zn(II) L-lactate | 0.73 | methoxyethoxy)ethoxy} | |
| Zn(II) Formate | 0.75 | benzene sulfonate | |
| Zn(II) Acetate | 0.71 | Cu(II) L-lactate | 0.72 |
| Zn(II) metacrylate | 0.70 | Cu(Il) Formate | 0.74 |
| Zn(II) Benzene sulfonate | 0.74 | Cu(II) Acetate | 0.70 |
| Zn(II) p-toluene sulfonate | 0.72 | Cu(II) Acrylate | 0.69 |
| Zn(II) Propionate | 0.69 | Cu(II) Benzene sulfonate | 0.72 |
| Zn(II) Butyrate | 0.68 | Cu(II) p-toluene sulfonate | 0.72 |
| Zn(II) Gluconate | 0.73 | Cu(II) Propionate | 0.73 |
| ZnSO₄ | 0.72 | Cu(II) Butyrate | 0.69 |
| No treament | 1.10 | Cu(II) Gluconate | 0.70 |
| | | CuSO₄ | 0.70 |

Table 1 shows that the optical density of the medium containing an agent is lower than the reference containing no inhibitor, The agents of the present invention show the inhibition of the activity of a style-specific S RNase.

It is well known that gametophytic self-incompatibility occurs in nearly one-half of all the families of angiosperms, including the Rosaceae (apples, pears, cherries, almonds, plums, mango, etc), the Solanaceae (tomatoes, petunia, potatoes, tobacco, etc), the Scrophularaceae, and many grasses. To verify the suppression of gametophyfic self-incompatibility with an agent of the present invention, we carefully chose several self-incompatibility plants from, the Rosaceae and the Solanacease which are well known to accumulate S-RNase in their pistil for their SI system.

### EXAMPLE 4

### Breakdown of the Self-incompatibility in Lycopersicon peruvianum by an S RNase Inhibitor

To verify the inhibition of a style-specific S RNase and the suppression of SI system with an agent of the present invention in a practical cultivating Environment, a wild-type tomato (Lycopersicon peruvianum) which has a gametophytic SI system was cultivated in a greenhouse at genetically insulated environment and was treated with an S RNase inhibitor of the present invention.

To determine the treatment period of an S RNase inhibitor, the inhibitor was applied to flowers either at the early blooming period (budding formation period to full blooming), or the middle blooming period (full blooming), or the late blooming period (1 day after full blooming period of petal), respectively. Each inhibitors in 0.1 mM aqueous solution (except the ZnSO₄ (1 mM) and CuSO₄ (1.0 mM) solution) was treated enough to get-wet flowers ith a micro-spray at 9:00-11:00 AM when the pollination of plant occurs most actively. The experiment with 25 blooming flowers (organ containing a stamen, a stigma, a petal, etc.) was repeated 4 times and the fruition rate ws investigated and the results are shown in Table 2.

TABLE 2
Breakdown of the SI in Lycopersicon peruvianum by the agents

| | | Zn(II) | Cu(II) | Zn(II) | Cu(II) | | |
|---|---|---|---|---|---|---|---|
| | | 2- | 2- | 2-(2- | 2-(2- | | |
| agents(0.1 mM) & | | methoxy | methoxy | methoxy | methoxy | | |
| Blooming | | ethoxy | ethoxy | ethoxy)ethoxy | ethoxy)ethoxy | ZnSO₄ | CuSO₄ |
| period | | acetate | acetate | acetate | acetate | (1.0 mM) | (1.0 mM) |
| early | 7 days | 0% | 0% | 0% | 0% | >10% | >10% |
| (before full) | 6 days | 0% | 0% | 0% | 0% | >10% | >10% |
| | 5 days | 0% | 0% | 0% | 0% | >5% | >10% |
| | 4 days | <10% | <10% | <10% | <10% | >5% | <5% |
| | 3 days | >10% | >10% | >10% | >10% | <5% | <5% |
| | 2 days | >50% | >40% | >50% | >50% | 0% | 0% |
| | 1 day | >60% | >50% | >60% | >60% | 0% | 0% |
| full blooming | 0 day | >40% | >40% | >50% | >50% | 0% | 0% |
| late | 1 day | 0% | 0% | 0% | 0% | 0% | 0% |
| (after full) | 2 days | 0% | 0% | 0% | 0% | 0% | 0% |

As shown in Table 2, the rate of self-pollination of L. peruvianum was 10-60% when an Zn(II)/Cu(II) ethoxyacetate agent was treated at the early blooming period (4 days days before and at full blooming); on the other hand, the treatment of ZnSO₄ and CuSO₄ showed the self-pollination at the earlier period of 3-7 days before full blooming.

The field trial shows that Zn(II)/Cu(II) ethoxyacetate agents (0.1 mm) of the present invention are more efficiently absorbed by L. peruvianumand the absorbed Zn(II) or CU(II) ethoxyacetates are stayed 1-2 days, which is advantageus to plant growers.

### EXAMPLE 5

### Breakdown of the Self-incompatibility in Hongro Apple by an S RNase Inhibitor

In the field application experiment, Hongro apple (the Rosaceae) which has a very low self-pollination rate (<5%) was isolated single-genetically by covering up whole plants with a fine-meshed net to exclude any pollinating insects. The agent of the present invention was treated enough to get-wet flowers at various concentrations with a micro-spray at 9:00-11:00 AM. The target of the agent was the first-blooming primary apple flower.

The self-pollination rate was investigated 25 days after the treatment and compared with no treatment and artificial cross-pollination. The results are shown in Table 3.

TABLE 3
Breakdown of the SI in Hongro apple by the angents.

| | concentration | | | | |
|---|---|---|---|---|---|
| Agents | 1.0 mM | 0.30 mM | 0.10 mM | 0.03 mM | 0.01 mM |
| Zn(II) 2-methoxy ethoxy acetate | >60% | >60% | >60% | >40% | >10% |
| Zn(II) 2-ethoxy ethoxy acetate | >60% | >60% | >50% | >20% | >5% |
| Cu(II) 2-methoxy ethoxy acetate | >50% | >50% | >50% | >30% | >10% |
| Zn(II) 2-(2-methoxy ethoxy) | >60% | >60% | >60% | >40% | >10% |
| acetate | | | | | |
| Cu(II) 2-(2-methoxy ethoxy) | >50% | >50% | >50% | >30% | >10% |
| acetate | | | | | |
| Zn(II) 2-{2-(2-methoxy | >50% | >50% | >50% | >30% | >10% |
| ethoxy)ethoxy} acetate | | | | | |
| Cu(II) 2-{2-(2-methoxy | >50% | >50% | >50% | >20% | >10% |
| ethoxy)ethoxy} acetate | | | | | |
| Zn(II) propionate | >50% | >50% | >50% | >30% | >10% |
| ZnSO4 | <10% | 0% | 0% | 0% | 0% |
| CuSO4 | <10% | 0% | 0% | 0% | 0% |

| | |
|---|---|
| no treatment | <4% |
| artificial cross pollination | >50% |

The agents of the present invention give about 50-60% self-pollination at over 0.1 mM, which is comparable with artificial cross-pollination and much more effective than ZnSO₄ and CuS0₄.

### EXAMPLE 6

### Investigation of the Side-effect by the Agents Toward Hongro Apple Flowers

To investigate the side-effect of the agent, various concentrations of the agents were treated to the flowers of Hongro apple. The side-effect of the agents were listed in Table 4. The index of 0 indicates that no side-effect is observed, and it is same as no treatment of the agents; the index of 1 means the side-effect are observed in flowers, but they recover to normal fruition in a week; the index of 2 is there indicates a fall-out of flowers and 10% decrease in fruition rate; and the index of 3 indicates that there is about 40% loss, the index of 4 is 60% loss, and index of 5 indicates there is a severe loss in fruition,

TABLE 4
Investigation of the side-effect by the agents.

| agents | 1.0 mM | 5.0 mM | 20.0 mM |
|---|---|---|---|
| Zn(II) 2-methoxyethoxy acetate | 0 | 0 | 1 |
| Cu(II) 2-methoxyethoxy acetate | 0 | 0 | 2 |
| Zn(II) 2-(methoxyethoxy)ethoxy acetate | 0 | 0 | 1 |
| Cu(II) 2-(methoxyethoxy)ethoxy acetate | 0 | 0 | 1 |
| Zn(II) propionate | 0 | 0 | 1 |
| Cu(II) propionate | 0 | 0 | 1 |
| ZnSO₄ | 2 | 5 | 5 |
| CuSO₄ | 3 | 5 | 5 |
| no treatment | 0 | 0 | 0 |

The agents of the present invention are safe enough to the flower organ in early bloom period up to 5.0 mM and shows slight side-effect at 20.0 mM, which is much safer compared to ZnSO₄ and CuSO₄.

### EXAMPLE 7

### Breakdown of the Self-incompatibility in 20-century Pear by an S RNase Inhibitor

In a field test, 20-Century pear (the Rosaceae) which has self-incompatibility system was isolated single-genetically by covering up selected branches or whole plants with a fine-meshed net to exclude any pollinating insects. The aqueous of 600 μM solution of an agent of the present invention was treated enough to get-wet flowers with a micro-spray at 9:00-11:00 AM. The agent solution was micro-sprayed 2 times; first at 5 days before full bloom and second at 2 days before full bloom. The reference was artificial cross-pollination at full bloom. The fertilization rate was investigated 14 days after the treatment and compared with no treatment and artificial cross-pollination. The results are shown in Table 5.

TABLE 5
Breakdown of the SI in 20-century pear by the angents (600 μM).

| | fertilization | | fertilization |
|---|---|---|---|
| agents | rate | agents | rate |
| Zn(II) propionate | 45% | Cu(II) propionate | 53% |
| Zn(II) 2- | 53% | Cu(II) 2- | 58% |
| methoxyethoxy | | methoxyethoxy | |
| acetate | | acetate | |
| Zn(II) 2- | 51% | Cu(II) 2- | 53% |
| (methoxyethoxy) | | (methoxyethoxy) | |
| ethoxy acetate | | ethoxy acetate | |
| Zn(II) gluconate | 48% | Cu(II) gluconate | 51% |
| artificial | 85% | no treatment | 3.0% |
| cross-pollination | | | |

### EXAMPLE 8

### Breakdown of Self-incompatibility and Seed Production of Safifia purple by the Agents

To establish the application method of the SI suppressing agent for the seed production, a field experiment was performed with Safinia purple ( the Solanaceae, a petunia developed by Suntory Ltd).

To a 15 cm-radii round pot, were added fine soil (pH 5.6) and 2 gr of complex fertilizer (including N, P, K 8% each) and they were mixed well. Safinia purple of 10 cm height were planted and raised in a green house for 2 weeks. At the period of 30 % bloom the diluted aqueous solutions of Zn(II) propionate or Cu(II) propionate agent were micro-sprayed enough to wet a flower and a style(3 ml). Two days after treatment of the agent, self-pollen was pollinated to its own style and the seed production was investigated. The experiments were repeated twice.

TABLE 6
Breakdown of Self-incompatibility of Safinia purple by the Agents
and Seed Production

| | | self-pollination | | seed production |
|---|---|---|---|---|
| | concn, | relative (%) | pollination | relative (%) |
| agent | μM | to control | ratio (%) | to control |
| Zn(II) | 1000 | 2000 | 64.5 | 1628.6 |
| propionate | 300 | 2100 | 63.6 | 1128.6 |
| | 100 | 1600 | 47.1 | 1057.1 |
| | 30 | 1400 | 42.4 | 442.9 |
| | 10 | 1000 | 29.4 | 514.3 |
| Cu(II) | 1000 | 3200 | 76.2 | 2342.9 |
| propionate | 300 | 2600 | 74.3 | 1471.4 |
| | 100 | 3800 | 82.6 | 2228.6 |
| | 30 | 2500 | 52.1 | 1714.3 |
| | 10 | 2000 | 47.6 | 485.7 |
| no agent | control | 100 | 3.4 | 100 |

From the results of the Example 3, 4, 5, 7 and 8, it is clearly shown that the agents of the present invention breakdown the self-incompatibility of gametophytic self-incompatible Safinia purple.

1. An agriculturally active composition comprising a self-incompatibility regulating compound having the chemical formula:
MLₙ.yX.w H₂O
wherein:
M is a cation of either copper(II) or zinc(II);
L is a chelate or complex-forming moiety associated with the cation M which is either an O-donor or N-donor or S-donor or any combination of them;
X is an anionic moiety to balance the total charge of MLₙ to neutral;
n is an integer in the range of from 0 to 6;
y is an integer in the range of from 0 to 2; and
w is an integer or fraction in the range of from 0 to 24.

2. A composition as claimed in claim 1, wherein n is 1 and L is bibentate or polydentate ligand or muti-complex-forming moiety.

3. A compoisiton as claimed in claim 1, wherein n is 2 and L's are the same kind of chelates or different chelates each other.

4. A composition as claimed in claim 1, wherein additional molecules are complexed to neutralize the charge of the compound having the chemical formula.

5. A composition as claimed in claim 1, wherein L is a lipophilic ligand from the class of either oxygen-donors, sulfr-donors or nitrogen-donors; a conjugate base molecule from the class of carboxylic acids, organo-sulfonic acids, organo-sulfinic acids, organo-sulfenic acids, organo-phosphonic acids, thiocarboxylic acids, alcohols, thiols, phenols, thiophenols, oximes, sulfonamides, sulfonylureas, imides, acetoacetates and thiocarbamate; ethylenediamines, imidazole, pyridines and pyrimidines.

6. A suspension or emulsion concentrate comprising a composition as claimed in claim 1 and thickening agent.

7. A suspension concentrate as claimed in claim 6 comprising from 5 to 90 wt. % of a compound of formula I as claimed in claim 1, from 0 to 50 wt. % of another active ingredient, from 0 to 10 wt. % of thickening agent and/or surfactants and/or other performance materials.

8. A method for the breakdown of the self-incompatibilty of a gametophytic self-incompatible plant which comprises applying a composition as claimed in claim 1 in solid form or in solution form.

9. A method for the production of the self-pollinated seed which is self-fertilized from a gametophytic self-incompatible plant which comprises applying a composition as claimed in claim 1.

10. A method for the production of the self-pollinated seed which is self-fertilized from a gametophytic self-incompatible plant which comprises applying a composition as claimed in claim 6.
